(19) United States
(12) Patent Application Publication
(10) Pub. No.: US 2016/0339367 A1
(43) Pub. Date: Nov. 24, 2016

(54) Device for Separating and Removing Sieve Material from a Flowing Liquid Contaminated with Sieve Material

(71) Applicant: HUBER SE, Berching (DE)

(72) Inventors: Franz Spenger, Roettenbach (DE); Christian Bruederl, Schernfeld (DE); Christian Breinl, Berching (DE)

(21) Appl. No.: 15/158,735

(22) Filed: May 19, 2016

(30) Foreign Application Priority Data
May 20, 2015 (DE) 10 2015 108 006.0

(51) Int. Cl. B01D 29/64; C02F 1/00; B01D 29/44

(52) U.S. Cl. CPC B01D 29/6484; B01D 29/445; C02F 1/004; C02F 2303/16

(57) ABSTRACT

A device for separating and removing sieve material from a flowing liquid includes a sieve grate that forms a sieve surface and is fixed to a frame. The sieve grate has several grate bars arranged beside one another and with at least some sections separated from one another by spaces. At least one cleaning rake has numerous cleaning prongs, the cleaning rake being movable along the front side of the sieve grate using a drive in such a way that at least sections of the cleaning prongs engage in the above-mentioned spaces when passing the sieve grate to remove sieve material held back by the sieve grate and convey it toward a device discharge. The cleaning rake has cleaning prongs that engage with variable depth into the above-mentioned spaces of the sieve grate.

### CROSS-REFERENCE TO RELATED APPLICATIONS

This application claims benefit to German Patent Application No. 10 2015 108 006.0, filed May 20, 2015 which is incorporated in its entirety by reference herein.

### TECHNICAL FIELD

The disclosure relates to a device for separating and removing sieve material from a flowing liquid contaminated with sieve material, for example sewage, wherein the device has a sieve grate that forms a sieve surface and is fixed to a frame, wherein the sieve grate has several grate bars arranged beside one another and with at least some sections separated from one another by spaces, wherein the sieve grate has a front side on which flowing liquid flows while the device is operating, wherein the device comprises at least one cleaning rake with numerous cleaning prongs, wherein the cleaning rake is movable along the front side of the sieve grate using a drive in such a way that at least sections of the cleaning prongs engage in the above-mentioned spaces when the sieve grate passes in order to remove sieve material held back by the sieve grate and convey it toward a device discharge.

### BACKGROUND

Such sieve devices have been sufficiently known in the state of the art and serve, for example, to remove coarse sieve material (wood, stones, etc.) from sewage flowing in a sewer. To accomplish this, the sieve device is integrated into the sewer in such a way that the sieve surface extends perpendicularly or slightly obliquely upward starting from the sewer bed. To allow the accumulating sieve material that has been held back by the sieve grate formed by the sieve surface to be discharged, the sieve surface extends mostly above the maximum expected water level.

The rotating operation of the cleaning rake (several of which can also be used) finally conveys the sieve material along the front side of the sieve surface upwards towards a discharge, where it is removed from the cleaning rake using a scraper, for example.

A generic sieve device is described, for example, in connection with FIG. 1 of DE 10 2012 103 058 A1.

If the individual cleaning rake must remove sieve material that got stuck in the sieve grate, then a relatively large force is exerted on it that increases with the number of cleaning prongs and the quantities of sieve material to be removed, and they can either damage the cleaning rake or overload the drive that moves the cleaning rake.

The task of the present disclosure is therefore to suggest a corresponding device that in this regard differs positively from the known state of the art.

### SUMMARY

This task is solved by a device having the characteristics of the present disclosure.

According to the disclosure, the device is thus characterized by having cleaning prongs in the cleaning rake that engage with different depth in the above-mentioned spaces of the sieve grate. In other words, the cleaning rake thus has a first type of cleaning prongs that extend farther between the grate bars allocated to them than a second type of cleaning prongs (needless to say, there can also be a third, fourth, etc. type of cleaning prongs, whose engagement depth differs from the one of the other types of cleaning prongs). Thus, whereas a part of the cleaning prongs removes the sieve material completely from the spaces allocated to them because the corresponding cleaning prongs engage relatively far into the spaces, the remaining cleaning prongs comb through the spaces allocated to them only down to a certain depth (the “engagement depth”), as seen from the front side of the sieve grate. If sieve material is now located at a certain depth of the sieve grate, then it is grabbed only by the cleaning prongs that engage deeper into the spaces, so that the total load acting on the cleaning rake is lower than in the case in which all cleaning rakes engage fully in the spaces all the time, as is known from the state of the art. For example, it could be conceivable for the cleaning prongs of a cleaning rake to have two different engagement depths, in which case the cleaning prongs with great engagement depth alternate with the cleaning prongs with less engagement depth.

It should be additionally pointed out here that all cleaning prongs of every cleaning rake should engage at all times into the spaces of the sieve grate, although the engagement depth of the individual cleaning prongs varies in a way according to the disclosure.

In particular, it is extremely advantageous for the device to have at least two cleaning rakes that pass the sieve grate in succession when the device is operating, i.e. seen in a movement direction of the cleaning rakes. In this context, it is advantageous if the cleaning rakes have in each case cleaning prongs with greater and smaller engagement depth, wherein the cleaning prongs of the first cleaning rakes are arranged staggered in such a way to the cleaning prongs of the second cleaning rake, that the individual spaces are successively combed through both by cleaning prongs with greater engagement depth and by cleaning prongs with smaller engagement depth. In this case, the individual spaces are cleaned partially in succession or step by step, in that the cleaning prongs of a cleaning rake that engage deeper remove the sieve material from the sieve grate that the cleaning prongs with smaller engagement depth of the preceding cleaning rake could not grab.

It is also advantageous if at least one part of the cleaning prongs (preferably all of them) engages (or engage) in the spaces without fully penetrating the sieve grate. Thus, whereas the sieve grate has a depth of X mm as seen from the liquid's flowing direction, it is useful if at least the cleaning prongs with smaller engagement depth, preferably all cleaning prongs, have an engagement depth of (X-Y) mm. In this way, the grate bars can have a relatively large depth and therefore stiffness as well (the grate bars can be several meters long), while on the other hand, the cleaning prongs are relatively short to almost rule out their bending or breaking.

Additional advantages are gained if the grate bars end at a common plane in the area of the front side of the sieve grate (at least in sections). Thus, the grate bars have in each case an upstream-pointing end portion, with regard to the flowing liquid, which end portion makes first contact with the flowing sieve material, wherein the end portions of all grate bars lie preferably at least over a certain area in a common plane. In other words, preferably no grate bar protrudes from the sieve surface of the sieve grate.

It is especially advantageous for the cleaning rake to have a first type of cleaning prongs and at least a second type of cleaning prongs, wherein similar cleaning prongs engage in the spaces allocated to them with the same depth. While the form of the cleaning prongs of the individual types of cleaning prongs can also differ, they especially have a different engagement depth and, in particular, a different length as well (wherein, within the scope of the invention, the length of a cleaning prong is defined as the spatial extension of the cleaning prong in the direction of the sieve grate). In any case, it is an advantage when cleaning prongs with greater engagement depth alternate with cleaning prongs with smaller engagement depth.

Generally, it is advantageous if cleaning prongs adjacent to one another engage in each case in the spaces allocated to them with different depth and/or have a different length. In other words, cleaning prongs that are directly adjacent to one another should not have the same length and/or engagement depth, although three or more cleaning prong types having different lengths and/or engagement depths can be present. In addition, the distances between cleaning prongs are preferably always constant.

It is especially advantageous if a first part of the cleaning prongs has a length that is at least 1.2 times, preferably at least 1.5 times, very preferably at least 2 times the length of another part of the cleaning prongs. Thus, the longer cleaning prongs should be, as much as possible, significantly longer than the shorter cleaning prongs, so that sieve material not reached by the shorter cleaning prongs can be removed from the sieve grate by the longer cleaning prongs of a successive cleaning rake.

However, it also advantageous when a first part of the cleaning prongs is no more than 3 times, preferably no more than 4 times, very preferably no more than 5 times longer than the length of another part of the cleaning prongs. If the magnitude mentioned above is exceeded, the result would be that almost all the sieve material would need to be removed from the longer cleaning prongs or that the longer cleaning prongs would be so long that their bending would be feared.

It is also extremely advantageous if the grate bars have widened sections in the area of the above-mentioned front side of the sieve grate for limiting the clear width of the corresponding spaces. For example, the grate bars could have a lenticular or oval design in a cross-section running perpendicularly to their longitudinal extension in the sections that form the front side of the sieve grate. These sections finally merge with a narrower section, so that the distance between the widened sections of adjacent grate bars determines the retention capability of the sieve grate. Preferably, only a part of the cleaning prongs (preferably every second one) extends all the way into the area in which the magnitude of the clear width limited by the widened sections of the corresponding spaces is minimal (i.e. the distance between adjacent widened sections that runs parallel to the sieve surface). In the final analysis, it is advantageous if the thickest spot of the widened sections is passed only on one of two sides of a cleaning prong of a cleaning rake when the device is operating.

It is thus advantageous if only every second cleaning prong extends into the area in which the magnitude of the clear width limited by the widened sections of the corresponding spaces is minimal, because here the sieve material held back by the sieve grate is more likely to get stuck, so that the force acting on a cleaning rake can be reduced when not all cleaning prongs make contact with the stuck sieve material.

There are additional advantages if at least sections of the cleaning prongs and grate bars can be moved sideways relative to one another. This can be achieved either by bending the cleaning prongs slightly sideways (with regard to the movement direction of the cleaning rake while the device is operating). In particular, at least sections of the cleaning prongs can be made of plastic.

It could also be possible to mount the cleaning prongs of the cleaning rake in such a way that they can be moved sideways back and forth with regard to the above-mentioned movement direction and the sieve grate. In other words, it can be advantageous if at least one part of the cleaning prongs (preferably all of them) is mounted so the part can be moved in a direction that runs parallel to a flat section of the sieve surface of the sieve grate and perpendicular to the movement direction of the cleaning rake that it has while moving along the front side of the sieve grate.

Such freedom of movement has the advantage that the cleaning prongs can adjust to the course of the grate bars. If they are not fully parallel to the direction of movement of the cleaning rake, then the cleaning prongs can nonetheless follow the free spaces available between the grate bars without causing a tilting of the cleaning prongs while doing so.

In the final analysis, the cleaning prongs are, on the one hand, movably mounted in conveying direction and, on the other hand, perpendicularly to it, and in the case of the conveying direction it is always the same direction in which the cleaning rake moves during the movement induced by the drive (thus, the conveying direction must not run in a straight line).

### BRIEF DESCRIPTION OF THE DRAWINGS

Additional advantages of the disclosure are described in the following embodiments, which show in each case:

FIG. 1 is a side view of a device for removing sieve material from sewage,

FIG. 2 is a side view of another device for removing sieve material from sewage,

FIG. 3 is a top view of a cleaning rake known from the state of the art engaged with a sieve grate,

FIG. 4 is a top view of a cleaning rake designed according to the disclosure engaged with a sieve grate, and

FIG. 5 is a top view of another embodiment of a cleaning rake designed according to the disclosure engaged with a sieve grate.

### DETAILED DESCRIPTION

To begin with, it must be mentioned that in figures showing several similar structural parts or sections (as is the case with the cleaning prongs 7, for example), sometimes only one or two of several similar structural parts or sections are provided with reference characters to ensure good clarity.

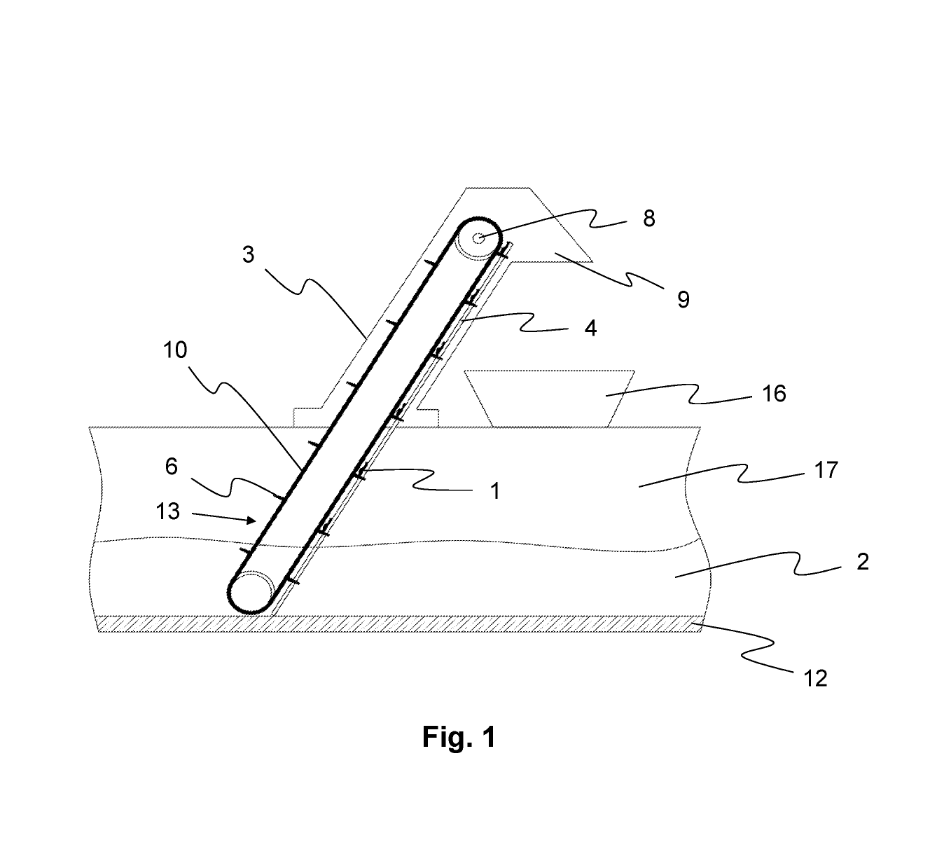

FIG. 1 shows a device (rake) according to the disclosure that is integrated into a sewer 17 to separate and remove sieve material 1 (e.g. in form of stones, branches, etc.). The device has a sieve grate 4 projecting obliquely from the top into the sewage 2 that is connected to a frame 3 of the device through fastening elements (not shown) and, if needed, to the sewer bed 12 of the sewer 17 as well.

Furthermore, and with regard to the sheet plane, the device has two pulling bodies 10 (e.g. in form of circulating chains) arranged behind one another and separated from each other, movable around the sieve grate 4 using a drive 8 and connected to one another via several cleaning rakes 6 lying in between (possibly, only one cleaning rake 6 might also be sufficient). The pulling bodies 10 are led along their path via lateral guides, wherein the guide can be placed in the upper and lower return area, but also in the intermediate areas in which the pulling bodies 10 run parallel to one another.

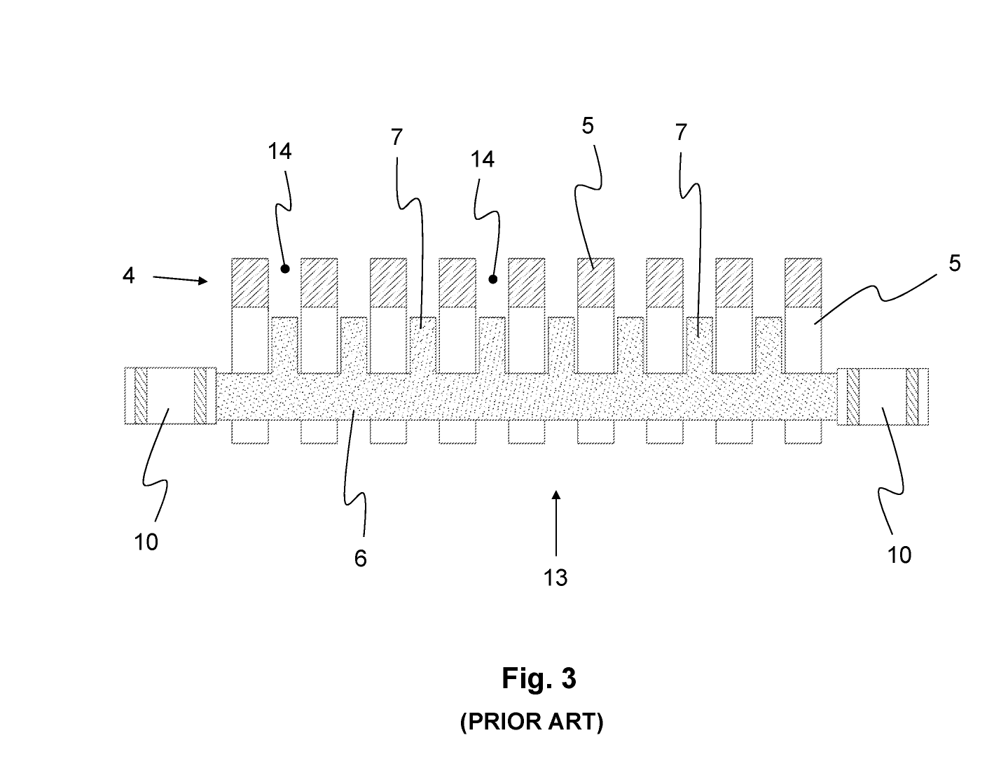

The cleaning rake 6 comprises, in turn, many cleaning prongs 7 arranged beside one another that engage into the spaces 14 of the sieve grate 4 when the cleaning rake 6 skims by the front side 13 of the sieve grate 4 pointing upstream in conveying direction (in FIG. 1, in clockwise direction) due to the movement of the pulling bodies 10 (cf. also FIGS. 3 to 5).

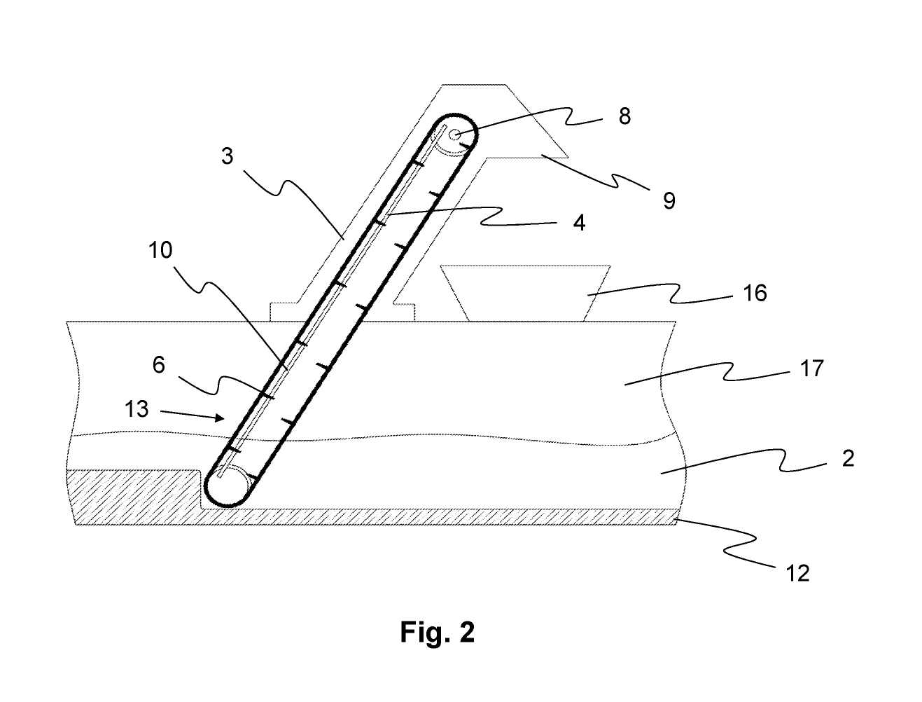

The sieve material 1 held back by the sieve grate 4 (in FIGS. 1 and 2, the sewage flows from left to right) is finally grabbed by the cleaning rakes 6 or their cleaning prongs 7 and transported upwards. Before passing the upper turning point, it finally reaches the area of a discharge 9 (possibly through a guide plate) and from there reaches the exterior, which can be a container 16. The cleaning rake 6 is finally once again guided to a lower turning point so the cycle can begin again from the start.

Comparing FIGS. 1 and 2, it can be seen that the movement path of the cleaning rakes 6 does not have to pass fully in front of the sieve grate 4 (with respect to the direction in which the sewage 2 flows). Rather, a design shown in FIG. 2 is also conceivable, in which the cleaning rakes 6 “circle” the sieve grate 4 in the lateral view shown.

As can now be seen in FIG. 3 (known state of the art), it had been customary so far for all cleaning prongs 7 of a cleaning rake 6 to engage with the same depth into the spaces 14 available between the grate bars 5 of the sieve grate 4. In this case, when every cleaning rake 6 passes the sieve grate 4, it cleans the spaces 14 thoroughly, i.e. all held-back sieve material 1 is fully removed.

Contrary to this, it is provided in the present disclosure that the device has one or more cleaning rakes 6, wherein the cleaning prongs 7 of a cleaning rake 6 engage with different depths into the above-mentioned spaces 14 of the sieve grate 4.

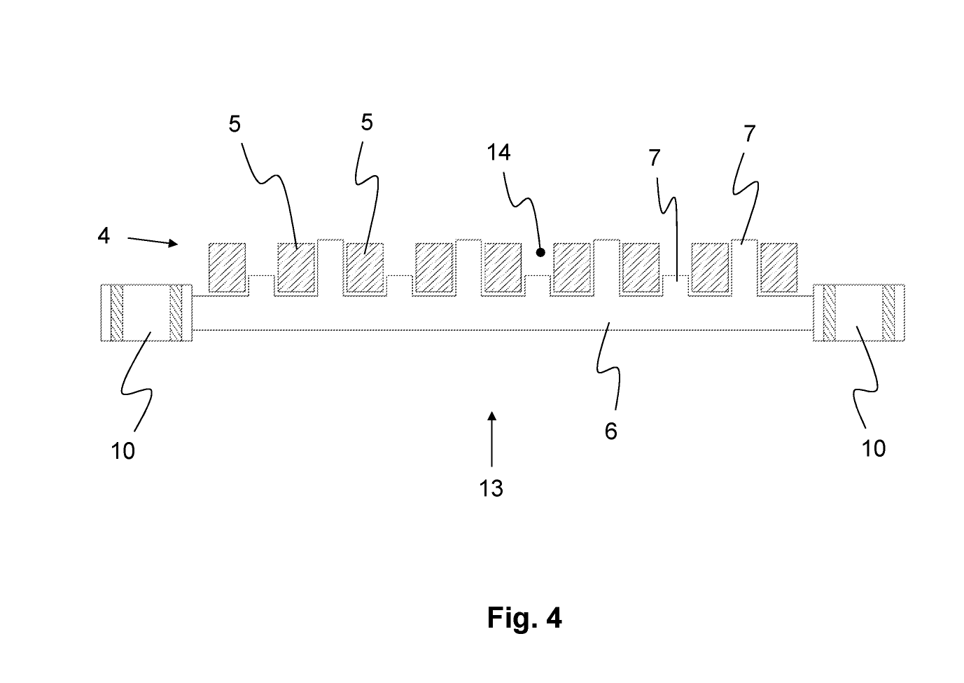

A possible embodiment is shown schematically in FIG. 4 (where contrary to FIG. 3, the view was chosen so that it runs parallel to the longitudinal extension of the grate bars 5). As can be seen in this Figure, the cleaning prongs 7 have different engagement depths, i.e. they extend with different depths into the spaces 14 available between the individual grate bars 5.

The advantage of this solution lies in the fact that the strain being exerted on the respective cleaning rake 6 is lower as if all cleaning prongs 7 would have a length L sufficient to remove the held-back sieve material 1 fully from the spaces 14. In order to allow a complete cleaning of the sieve grate 4 also in the case of the solution according to the disclosure, it could finally be advantageous for the device to have at least a second cleaning rake 6, in which case the longer cleaning prongs 7 of the second cleaning rake 6 should be placed in such a way that they engage in those spaces 14 that were grabbed through by the shorter cleaning prongs 7 of the (first) cleaning rake 6 shown in FIG. 4. This ensures that all spaces 14 are combed through once by a shorter and once by a longer cleaning prong 7 after the two cleaning rakes 6 have passed.

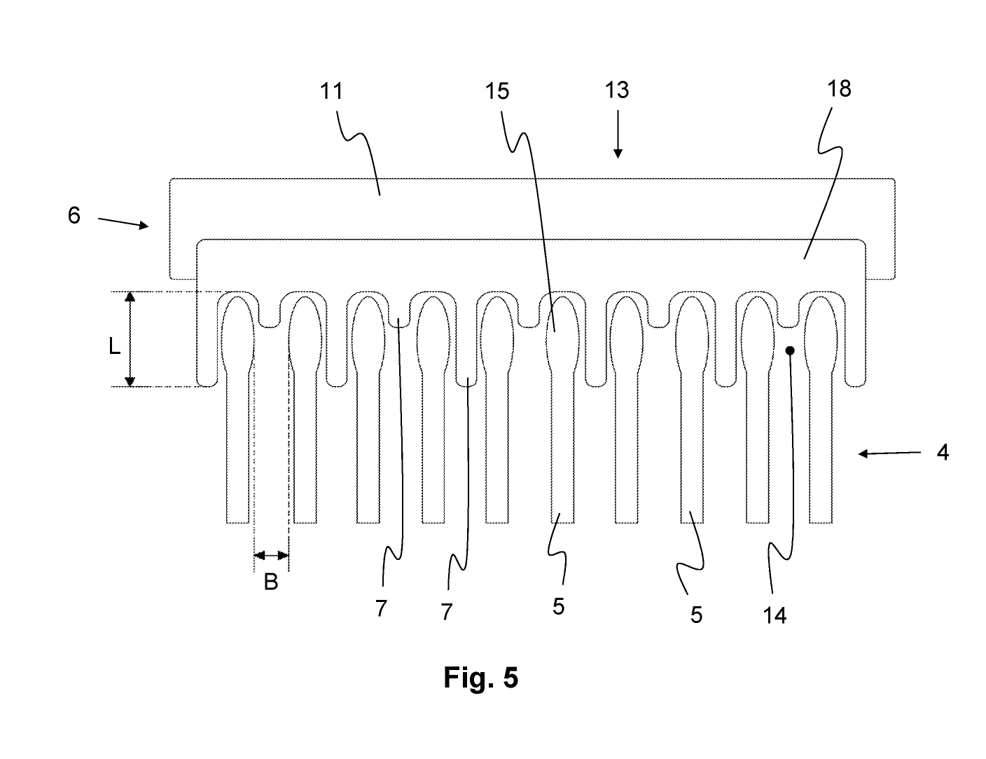

FIG. 5 shows another embodiment of a cleaning rake 6 according to the disclosure. Contrary to FIG. 4, a solution is shown here in which no cleaning prong 7 grabs fully through the sieve grate 4. This is not necessary either, as the sieve surface to be cleaned practically ends in the widened sections 15 of the grate bars 5 shown, as the widened sections 15 determine the smallest clear width B between the neighboring grate bars 5 and by doing so, the sieve gap width of the sieve grate 4. In other words, it is therefore sufficient if the respective cleaning prongs 7 grab only through the area extending from the front side 13 of the sieve grate 4 to the area of the thickest widened section 15 of the grate bars 5. The length L of the longer cleaning prongs 7 should therefore be of a magnitude at least equal to the smallest distance between the front side 13 of the sieve grate 4 and the thickest spot of the widened section 15 of the grate bars 5.

Finally, FIG. 5 shows exemplarily for all possible designs that it can be advantageous for the cleaning prongs 7 to be part of a prong comb 18 that is, in turn, mounted on a separate carrier 11 that is finally connected to the pulling bodies 10.

The present invention is not restricted to the embodiments shown and described. Variations within the scope of the patent claims are just as possible as any combination of the characteristics described, even if they are shown and described in different sections of the description or the claims or shown and described in different embodiments.

### LIST OF REFERENCE CHARACTERS

1 Sieve material
2 Sewage
3 Frame
4 Sieve grate
5 Grate bar
6 Cleaning rake
7 Cleaning prongs
8 Drive
9 Discharge
10 Pulling body
11 Carrier
12 Sewer bed
13 Front side of the sieve grate
14 Space between two adjacent cleaning prongs
15 Widened section of the grate bar
16 Container
17 Sewer
18 Prong comb
L Length of a cleaning prong
B Clear width between two adjacent cleaning prongs

1. A device for separating and removing sieve material from a flowing liquid contaminated with sieve material, the device comprising:
a sieve grate that forms a sieve surface and is fixed to a frame, the sieve grate having several grate bars arranged beside one another and in at least some sections separated from one another by spaces, the sieve grate has having a front side on which the flowing liquid flows while the device is operating; and
at least one cleaning rake with numerous cleaning prongs, the cleaning rake being movable along the front side of the sieve grate using a drive in such a way that at least sections of the cleaning prongs engage in the spaces when passing the sieve grate to remove sieve material held back by the sieve grate and convey it toward a device discharge, the cleaning prongs engaging with variable depth into the spaces of the sieve grate.

2. A device according to claim 1, wherein the device has at least two of the cleaning rakes that pass the sieve grate in succession when the device is operating, wherein the cleaning rakes have both longer and shorter cleaning prongs, wherein the cleaning prongs of the first cleaning rake are offset in such a way with respect to the cleaning prongs of the second cleaning rake, that each of the spaces is successively combed through both by shorter and longer cleaning prongs.

3. A device according to claim 2, wherein at least one part of the cleaning prongs engages in the spaces without grabbing completely through the sieve grate while doing so.

4. A device according to claim 1, wherein at least some sections of the grate bars end in a common plane in the area of the front side of the sieve grate.

5. A device according to claim 1, wherein the cleaning rake has a first type of cleaning prongs and at least a second type of cleaning prongs, wherein each of the types of cleaning prongs engages with the same depth into the respective spaces allocated.

6. A device according to claim 1, wherein cleaning prongs within an adjacent pair of the cleaning prongs each engage in with different depth in the spaces allocated.

7. A device according to claim 1, wherein a first part of the cleaning prongs has a length that is at least 1.2 times as long as a length of another part of the cleaning prongs.

8. A device according to claim 1, wherein a first part of the cleaning prongs has a length that is no more than 3 times as long as a length of another part of the cleaning prongs.

9. A device according to claim 1, wherein the grate bars have widened sections in an area of the front side of the grate bar that limit a clear width of the corresponding spaces, wherein only one part of the cleaning prongs extends into the area.

10. A device according to claim 9, wherein only every second one of the cleaning prongs extends all the way into the area.

11. A device according to claim 1, wherein at least a section of the cleaning prongs and at least a section of the grate bars can be moved in a lateral direction relative to one another.

12. A device according to claim 6, wherein the cleaning prongs within an adjacent pair of the cleaning prongs each have a different length.
